(19) United States
(12) Patent Application Publication
(10) Pub. No.: US 2020/0138213 A1
(43) Pub. Date: May 7, 2020

(54) SYSTEMS AND METHODS FOR PREVENTING CROSS CONTAMINATION

(71) Applicant: Jason LEE, Newnan, GA (US)

(72) Inventor: Jason LEE, Newnan, GA (US)

(21) Appl. No.: 16/674,539

(22) Filed: Nov. 5, 2019

Related U.S. Application Data
(60) Provisional application No. 62/755,917, filed on Nov. 5, 2018.

(51) Int. Cl. A47G 19/24; B08B 1/00; B65D 51/24; B65D 47/06; B65D 23/10

(52) U.S. Cl. CPC A47G 19/24; B08B 1/006; B65D 23/104; B65D 51/245; B65D 47/06; B65D 51/242

(57) ABSTRACT

Systems and methods for preventing cross contamination including a grasping handle for use with a container. In example embodiments, the grasping handle can be integrally formed or removably mounted with the container or a cap that is removably connectable with the container. In one example embodiment, a dispensing cap having a grasping handle extending therefrom can be provided for attachment to a desired container. A packaged sanitary wipe can be provided for cleaning the grasping handle and a foil package thereof can cover at least a portion of the grasping handle to provide a sanitary barrier therebetween. Methods of preventing cross contamination when using condiments contained within containers are also disclosed.

### CROSS-REFERENCE TO RELATED APPLICATION

This application claims the benefit of U.S. Provisional Patent Application Ser. No. 62/755,917 filed Nov. 5, 2018, the entirety of which is hereby incorporated herein by reference for all purposes.

### TECHNICAL FIELD

The present invention relates to containers for dispensing materials stored therewithin, and more particularly to shakers for granular condiments, and to systems and methods for preventing cross contamination while using the containers.

### BACKGROUND

It is widely known that most restaurant tables are home to more bacteria fungus and viruses than is found in public restrooms. Many studies and reports bear this out. Even with this knowledge there has been very little progress made in addressing this unhealthy situation.

According to one example, the public's engagement with containers such as salt and pepper containers or shakers is substantially high, and the risk of cross contamination by touching a container (such as a salt or pepper shaker used in public spaces) is substantially high. FIG. 1 shows a pair of containers 10, for example, salt and pepper shakers according to the known prior art. The container 10 includes a body 16 extending from a first end 12 to a second end 14, and a contained spaced is defined within the body 16 (for containing the salt or pepper), and a threaded connector 20 includes one or more external threads and defines an opening 24 passing through the threaded connector 20 for providing access to the contained volume. A support base or surface 30 is provided at the second end 14, for example, which preferably provides for stabilizing and supporting the body 16 in the upright configuration. A cap 40 is provided for each container 10 and includes a cylindrical body 42, a substantially closed end 44 (defining one or more openings or passageways 45) and a substantially open end 46. The cap 40 is configured for attachment to the external threads of the opening 24 so as to allow for the dispensing of a granular material, for example, salt, pepper or other desirable granular or fine material (e.g., herbs, spices, etc.). Typically, threads are formed on an inner surface of the body 42 for providing coupling engagement with the threaded connector. In most cases, a person or customer grasps a portion of the body 16 of the container 10, and manipulates the same so as to dispense salt, pepper or other granular materials therefrom.

Accordingly, it can be seen that needs exist for preventing cross contamination in public spaces, for example in restaurants and other public spaces where physical touching among many users is a common occurrence. It is to the provision of systems and methods for preventing cross contamination that the present invention is primarily directed.

### SUMMARY

In example embodiments, the present invention provides systems and methods for preventing cross contamination. In example embodiments, the present invention relates to preventing cross contamination and pathogen vectors by using a physical barrier and anti septic protocol in restaurants. According to example embodiments of the present invention, the present invention relates to a container which is generally used in public spaces such as restaurants, for example, shakers for granular condiments such as salt and pepper. According to some example embodiments, the present invention relates to a handle attachment for shakers such as salt and pepper shakers.

In one aspect, the invention relates to a dispensing cap for a container including a cylindrical body and a grasping handle. The cylindrical body extending along a first axis and including a substantially closed end and an open end, the body including an outer peripheral surface defined between the substantially closed end and the open end, and the grasping handle extending from the cylindrical body.

In example embodiments, the grasping handle includes an engaged end and a free end oppositely extending from the engaged end, the engaged end generally connected to at least a portion of the cylindrical body, and the free end including a grasping portion proximal thereto. In example embodiments, the grasping handle is integrally formed with the cylindrical body. In example embodiments, wherein the grasping handle is removably connected with the cylindrical body. In example embodiments, wherein the engaged end is engaged with at least a portion of the outer peripheral surface of the cylindrical body.

In example embodiments, at least one opening formed in the substantially closed end of the cylindrical body. In example embodiments, threads formed on an interior portion of the outer peripheral surface of the cylindrical body for providing removable engagement with a threaded connector of a container. In example embodiments, the open end of the cylindrical body is configured for removable engagement with a connector of the container, and wherein the grasping handle thereof can be grasped so as to manipulate the container.

In example embodiments, the container includes a condiment container having a contained space for containing at least some quantity of a granular material. In example embodiments, a maximum dimension is defined between an outermost portion of the free end of the grasping handle and an opposite and outermost portion of the outer peripheral surface of the cylindrical body, wherein the maximum dimension is about 3.105 inches. In example embodiments, the grasping handle is oriented to be at least partially angled relative to a horizontal axis that is generally extending transverse relative to the first axis, the grasping handle defining an included angle of about 5 degrees relative to the horizontal axis. In example embodiments, the grasping handle includes an upper surface and a lower surface, the upper surface having at least one Braille letter formed thereon.

In another aspect, the invention relates to a condiment assembly including first and second containers and first and second dispensing caps. The first and second containers including a threaded connector and an internal volume for containing first and second granular materials, respectively. The first and second dispensing caps configured for removable engagement with the threaded connector of the first and second containers, respectively.

In example embodiments, the first and second dispensing caps each include a cylindrical body and a grasping handle, the cylindrical body including a substantially closed end and an open end, the cylindrical body including an outer peripheral surface defined between the substantially closed end and the open end, and the grasping handle including an engaged end and a free end oppositely extending therefrom. In example embodiments, the grasping handles of the first and second dispensing caps overlap each other in a nested configuration and are misaligned in a non-nested configuration.

In example embodiments, at least some spacing or clearance is provided between a lower surface of an upper grasping handle and an upper surface of a lower grasping handle. In example embodiments, the spacing between the dispensing caps is at least about 0.034 inches. In example embodiments, each of the first and second dispensing caps define a maximum dimension that is defined between an outermost portion of the free end of the grasping handle and an opposite and outermost portion of the outer peripheral surface of the cylindrical body, wherein the maximum dimension is about 3.105 inches. In example embodiments, wherein in the nested configuration, a maximum dimension is defined between outermost and opposite sides of the outer peripheral surfaces of the cylindrical bodies and with the grasping handles overlapping each other, wherein the maximum dimension is about 4.619 inches. In example embodiments, the maximum dimension of the dispensing caps in the nested configuration is about 1.5 times greater than the maximum dimension of one of the dispensing caps, and wherein the maximum dimension of the dispensing caps in the nested configuration is about 26% less than twice the maximum dimension of one of the dispending caps.

In another aspect, the invention relates to a container including a body, a cap and a grasping handle. The body extends from a first end to a second end, the first end including a threaded coupling having an opening extending therethrough, and the second end including a base or resting surface, and wherein the threaded coupling includes an opening for access within a contained volume of the body. The cap includes a collar having a substantially closed end and an open end, the substantially closed end including one or more passageways defined therethrough, and an inner surface of the collar having threads compatible for coupling engagement with the threaded coupling of the body. The grasping handle extends from at least a portion of the body and/or cap, wherein the grasping handle is configured so that a user can grasp it for manipulation of the container such that one or more materials contained within the contained volume can be dispensed from the passageways of the substantially closed end.

In some example embodiments, the grasping handle is removably attached to the body or the cap. In other example embodiments, the grasping handle is integrally formed with the body or the cap.

In another aspect, the invention relates to a container including a body extending from a first end to a second end. In example embodiments, the first end includes a threaded coupling having an opening extending therethrough, and the second end includes a base or resting surface. In example embodiments, a cap is provided and includes a collar having a substantially closed end, one or more passageways defined through the closed end, and the other end being open. In example embodiments, an inner surface of the collar includes threads compatible for coupling engagement with the threaded coupling of the body.

In example embodiments, a grasping handle is provided with the container such that a user can grasp it for manipulation of the container, for example, such that the granular(s) contained therein can be dispensed from the passageways of the closed end. In example embodiments, can be attached to the body of the container, and can be covered and grasped so as to not enable cross contamination and pathogen vectors.

In yet another aspect, the invention relates to a container including a body, a cap and a grasping handle. The body extends from a first end to a second end, wherein the first end includes a threaded coupling having an opening extending therethrough, and the second end includes a base or resting surface. The threaded coupling defines an opening for access within a contained volume of the body. The cap includes a collar having a substantially closed end and an open end, wherein the substantially closed end includes one or more passageways defined therethrough, and an inner surface of the collar has threads compatible for coupling engagement with the threaded coupling of the body. The grasping handle extends from at least a portion of the body and/or cap. In example embodiments, the grasping handle defines an elongate body.

In yet another aspect, the invention relates to a grasping handle for attachment to a container, the grasping handle including a generally elongate body and an attachment collar coupled to the elongate body. In example embodiments, the attachment collar is configured for engagement with a portion of the container (depicted as an annular channel) near the first end. In example embodiments, the attachment collar is integrally formed with the elongate body. In alternate example embodiments, the attachment collar is a separate piece attached to the elongate body. According one example embodiment, the attachment portion is substantially durable and resilient.

In yet another aspect, the invention relates to a replaceable cap for a condiment container. The condiment container includes a body having an open end and a substantially closed end. The substantially closed end includes one or more passageways such that one or more granular materials can pass therethrough. A grasping handle extends from at least a portion of the body, and the open end of the body is configured for removably coupling with an end connector of the condiment container.

In yet another aspect, the present invention relates to a method of preventing cross contamination in a restaurant when using condiments contained within containers including providing one or more condiment containers, the one or more condiment containers each having a grasping handle extending therefrom; providing a sanitary wrap, the sanitary wrap including a sanitary wipe enclosed within a cover or foil pouch; opening the foil pouch; removing the sanitary wipe; wiping the grasping handle with the sanitary wipe; covering the grasping handle with the foil pouch; grasping the grasping handle while the foil pouch remains thereon; and manipulating the container so as to dispense the condiment. In example embodiments, the method further includes using the sanitary wipe to clean a table, a menu or other potentially unsanitary objects present on a table at the restaurant.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a front perspective view of prior art containers sitting atop a support surface and having closure caps removed therefrom.

FIG. 2 is a perspective view of a pair of containers each having a dispensing cap according to an example embodiment of the present invention, each dispensing cap having a grasping handle attached thereto and positioned in a nested configuration.

FIG. 3 is a side view of the pair of containers of FIG. 2.

FIG. 4 is a top plan view of the dispensing caps of the containers of FIG. 3.

FIG. 5 is a cross-sectional view of the dispensing caps of FIG. 4 taken along line 5-5.

FIG. 6 is a cross-sectional view of the dispensing caps of FIG. 4 taken along line 6-6.

FIGS. 7A-D show a sequence of operation and method of use of the container and dispensing cap according to an example embodiment of the present invention.

FIG. 8A shows a grasping handle according to another example embodiment of the present invention.

FIG. 8B shows a grasping handle according to another example embodiment of the present invention.

FIG. 8C shows a container, a dispensing cap and the handle of FIG. 8A connected to a portion thereof according to another example embodiment of the present invention.

FIG. 8D shows a container, a dispensing cap and the handle of FIG. 8A connected to a portion thereof according to another example embodiment of the present invention.

FIG. 9 shows a container, a dispensing cap connected to the container and a grasping handle extending from the container according to another example embodiment of the present invention.

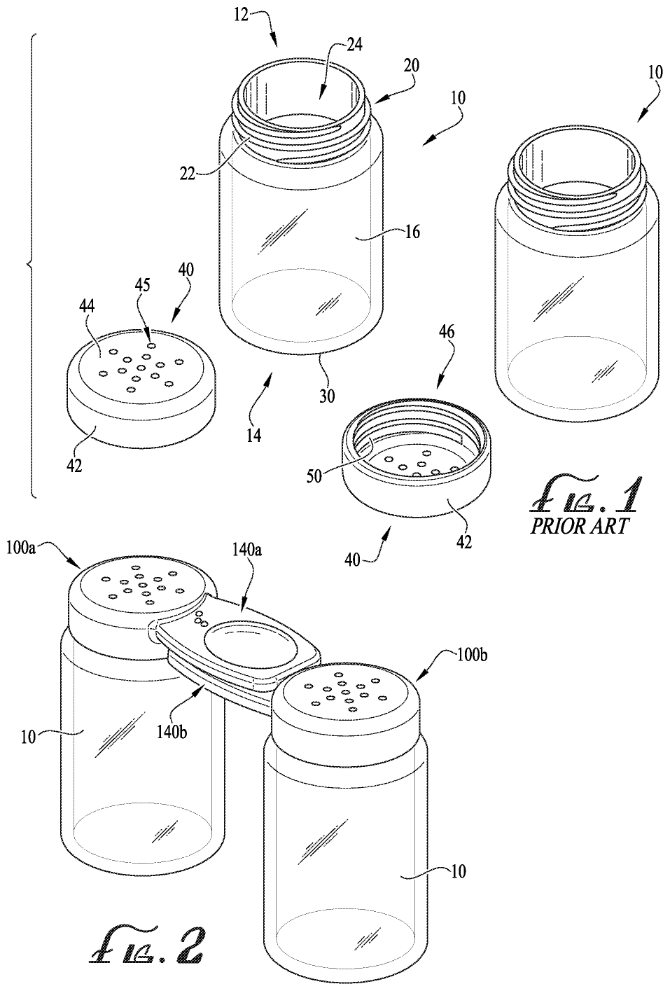

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

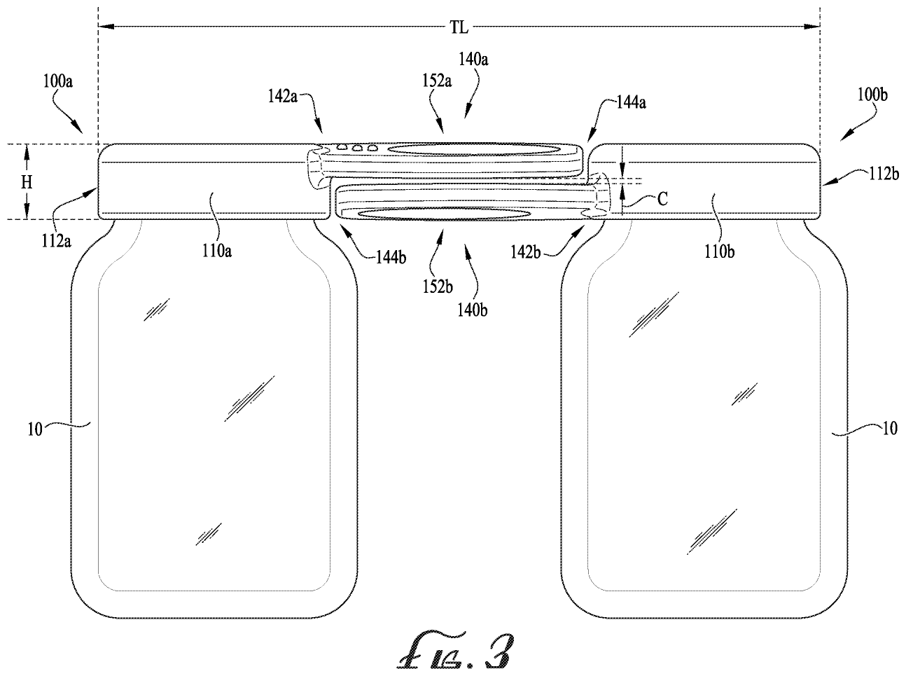

With reference now to the drawing figures, wherein like reference numbers represent corresponding parts throughout the several views, FIGS. 2-3 show a pair of containers 10 comprising dispensing caps 100a, 100b attached thereto according to an example embodiment of the present invention. According to example embodiments, one of the containers 10 is configured for containing a quantity of a first granular material and the other container is configured for containing a quantity of a second granular material, and for example, the dispensing caps 100a, 100b permit the first and second granular materials to be dispensed therefrom while substantially eliminating the chances of cross contamination or the spreading of diseases. According to example embodiments, the first granular material is salt or table salt, and for example, the second granular material is pepper or ground pepper. In alternate example embodiments, the containers can be configured to contain/dispense other materials, liquids, etc. as desired.

According to example embodiments, the dispensing caps 100a, 100b comprise grasping handles 140a, 140b attached thereto such that a user U can grasp to lift and manipulate the containers 10, respectively, for example, to dispense the first and second granular materials therefrom.

As depicted in FIGS. 3-6, the dispensing cap 100a, 100b comprises a collar or cylindrical body 110a, 110b comprising an outer peripheral surface 112a, 112b, a substantially closed top end 114a, 114b comprising one or more openings or passageways 120a, 120b, a generally opposite open bottom end 116a, 116b comprising threads 122a, 122b formed on an inner surface or portion of the cylindrical body 110a, 110b for providing releasable engagement with the threaded connector of the container 10, and a grasping handle 140a, 140b connected with the outer peripheral surface 112a, 112b of the cylindrical body 110a, 110b and outwardly extending therefrom. According to example embodiments, the openings 120a, 120b of the substantially closed top end 114a, 114b define a star or asterisk-like pattern, for example, comprising a plurality of cylindrical openings 120a, 120b positioned about the substantially closed top end 114a, 114b. According to one preferred embodiment, the substantially closed top end 114a, 114b comprises 13 cylindrical-shaped openings, for example, wherein each opening defines a diameter of about 0.079 inches. In other example embodiments, the openings can be sized, shaped and patterned as desired.

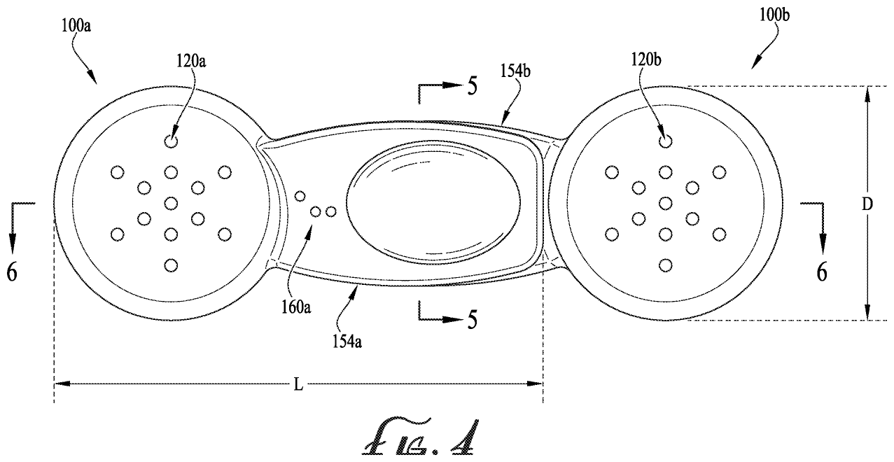

As depicted in FIGS. 3-4, the cylindrical body 110a, 110b comprises a thickness or height H of between about 0.25-0.85 inches, for example, about 0.482 inches according to one example embodiment. The outer diameter D of the cylindrical body 110a, 110b is generally between about 0.05-2.5 inches, for example, about 1.486 inches according to one example embodiment. According to one preferred example embodiment, the height H of the cylindrical body 110a, 110b is 0.482 inches and the outer diameter D is 1.486 inches. In other example embodiments, the height H and outer diameter D can be chosen as desired.

In example embodiments, the handle 140a, 140b is generally integrally formed with the cylindrical body 110a, 110b of the dispensing cap 110a, 100b, and thus, the dispensing cap 100a, 100b is a unitary piece. According to one example embodiment, the dispensing cap 100a, 100b is injection molded from a plastic or polymer material. In other example embodiments, the dispensing cap 100a, 100b can be formed or manufactured as desired. In alternate example embodiments, the cylindrical body 110a, 110b can be formed separately from the handle 140a, 140b, for example, to be permanently or irremovably connected together. Preferably, a user can easily grasp and manipulate the handle 140a, 140b such that a desired amount of salt/pepper can be dispensed therefrom. According to one preferred example embodiment, the handle 140a, 140b serves to virtually eliminate the possibility of cross contamination and the spread of disease in the restaurant setting (as will be described below).

In example embodiments, the handle 140a, 140b comprises a generally elongate body comprising an engaged end 142a, 142b that is connected to the outer peripheral surface 112a, 112b of the cylindrical body 110a, 110b and a free end 144a, 144b oppositely extending from the engaged end 142a, 142b (see FIG. 3). For example, as depicted in FIG. 4, the dispensing cap 100a defines a maximum dimension L (e.g., from the free end 144a to the outermost outer peripheral surface 112a of the cylindrical body 110a) of between about 1.75-5.35 inches, for example, about 3.105 inches according to one example embodiment. According to one preferred embodiment, the maximum dimension L is 3.105 inches. In alternate example embodiments, the maximum dimension L can be chosen as desired.

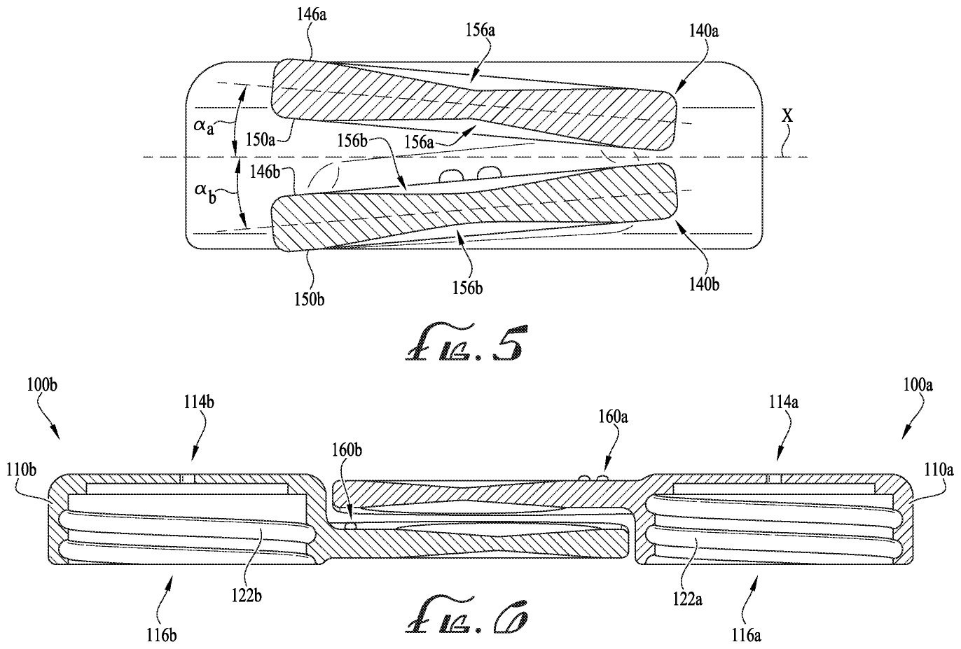

In example embodiments as depicted in FIG. 5, the handle 140a, 140b comprises an upper surface 146a, 146b, a lower surface 150a, 150b, a grasping portion 152a, 152b (see FIG. 3), curved side surfaces 154a, 154b (see FIG. 4) and depressions 156a, 156b formed on the upper and lower surfaces, for example, to provide the user with a comfortable and ergonomic grip when grasping the same (see FIGS. 3 & 5).

As depicted in FIGS. 2-6, the dispensing caps 100a, 100b are preferably configured to be at least partially nested or stacked together in a desired manner, for example, such that only a small footprint/area is needed to accommodate the containers 10 and the attached dispensing caps 100a, 100b, for example, when placed on a restaurant dining table or other desired surface. For example, according to some example embodiments, a condiment caddie or other basket/carrier can be provided for placement atop a surface and for containing the containers and dispensing caps 100a, 100b (either in the nested configuration or randomly placed therein).

In example embodiments, the grasping handle 140a of the dispensing cap 100a and the grasping handle 140b of the dispensing cap 100b are preferably mounted to opposite ends of the cylindrical body 100a, 100b, for example, such that the handles 140a, 140b can be aligned, nested or stacked together. In example embodiments, the grasping handle 140a outwardly extends from the outer peripheral surface 112a of the cylindrical body 110a near the substantially closed top end 114a, and the grasping handle 140b outwardly extends from the outer peripheral surface 112b of the cylindrical body 110a near the open bottom end 116b. As such, at least some amount of clearance is provided between the lower surface 150a of handle 140a and the upper surface 146b of the handle 140b. For example, according to one example embodiment, a clearance distance C of about 0.034 inches is provided therebetween. According to other example embodiments, a clearance distance C of more or less than 0.034 inches can be provided as desired.

Referring back to FIG. 3, dispensing caps 100a, 100b (containers 10 connected therewith) and the handles 140a, 140b thereof can be arranged in a nested configuration, for example, such that a maximum dimension TL that is defined between outermost portions of the dispensing caps 100a, 100b is between about 2.351-6.875 inches, for example, about 4.6 inches according to one example embodiment. According to another example embodiment, the maximum dimension TL is 4.6 inches. According to another example embodiment, the maximum dimension TL is 4.619 inches. Thus, according to example embodiments, the maximum dimension TL is about 1.49 times greater than the maximum dimension L of the dispensing cap 100a, 100b (e.g., where L=3.105 inches and TL=4.619 inches). As such, by providing nestable or stackable handles 140a, 140b, the maximum dimension TL is about 26% less than twice the maximum dimension L (e.g., 4.619/6.21). According to example embodiments, the handles 140a, 140b are aligned and generally stacked or overlap each other in the nested configuration, and for example, are misaligned and/or separated in a non-nested configuration.

FIGS. 5-6 show cross sectional views of the dispensing caps 100a, 100b (and handles 140a, 140b thereof) of FIG. 4 in the nested configuration. As depicted, the handles 140a, 140b are generally aligned relative to each other, for example, wherein the handle 140a is generally positioned atop handle 140b, and for example, wherein the outer curved surfaces 154a, 154b thereof generally align with each other. In example embodiments, the handles 140a, 140b are at least partially angled relative to the cylindrical body 110a, 110b that they extend from. For example, as depicted in FIG. 5, the handle 140a defines an angle αₐ relative to a horizontal axis X and the handle 140b defines an angle α_{b} relative to the horizontal axis X. In example embodiments, the angles αₐ, α_{b} are between about 2.5-15 degrees, for example between about 5-8 degrees according to some example embodiments. According to one preferred embodiments, the angles αₐ, α_{b} define an included angle of 5 degrees relative to the horizontal axis X. Preferably, the grasping handle 140a, 140b is designed to allow for maximum comfort of use by incorporating several features into the user/product interface. According to one example embodiment, the angled grasping handles 140a, 140b allow for easy pick up and placement with no odd angulations of the wrist or digits required by the user. In example embodiments, proper control of the application process is facilitated by the subtle contours and concavities found in the unique custom handle design (e.g., grasping portion 152a, 152b, curved side surfaces 154a, 154b, depressions 156a, 156b). According to the depicted example embodiment, the grasping handle 140a is positively angled relative to the axis X and the grasping handle 140b is negatively angled relative to the axis X. In other example embodiments, the grasping handles 140a, 140b can be angled as desired. According to one example embodiment, the handles are oriented to be substantially coplanar with the outermost planar surface of the closed end of the cylindrical body. In other example embodiments, the handles 140a, 140b can preferably be oriented as desired.

According to example embodiments, one or more unique identifiers can be provided on one or more portions of the dispensing caps 100a, 100b. According to one example embodiment, the upper surface 146a, 146b of the grasping handle 140a, 140b can be provided with a Braille descriptor or raised protrusions 160a, 160b, for example, to provide compliance with the Americans with Disabilities Act (ADA). As depicted in FIG. 6, a unique Braille identifier 160a, 160b is provided on the upper surface 146a, 146b of the grasping handle 140a, 140b generally near the engaged end 142a, 142b. In example embodiments, the identifier 160a comprises a Braille “P” for pepper and the identifier 160b comprises a Braille “S” for salt. According to other example embodiments, other indicia, branding or identifiers can be provided on one or more portions of the dispensing cap 100a, 100b (and/or grasping handle 140a, 140b thereof).

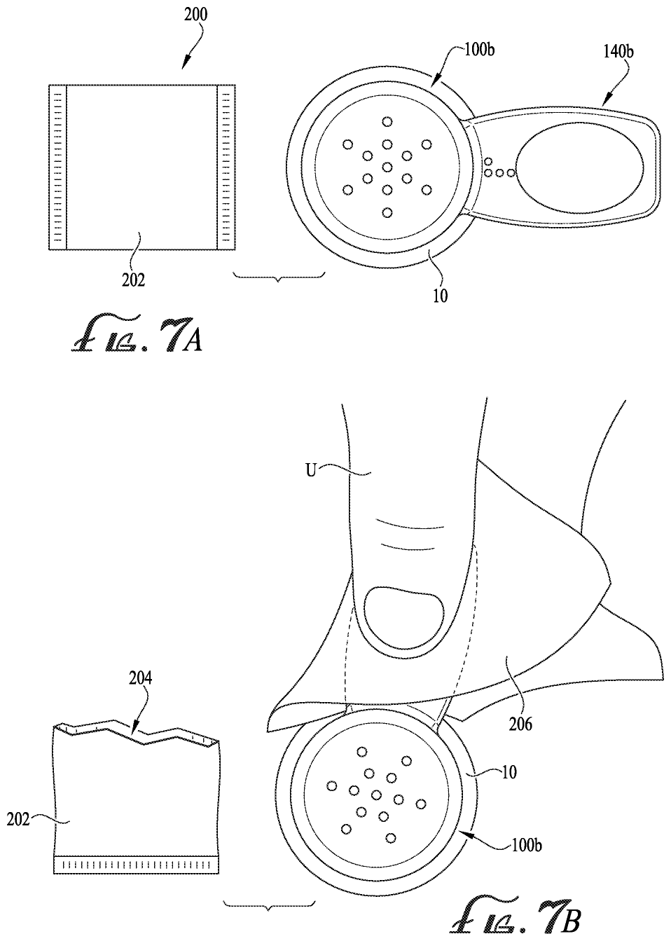

FIGS. 7A-D show an example method of use according to an example embodiment of the present invention. In example embodiments, a bacteria and biofilm wash and barrier protocol is used with the dispensing caps 100a, 100b (and grasping handle 140a, 140b), for example, which serves to virtually eliminate the possibility of cross contamination and the spread of disease in the restaurant setting (or other desired setting). According to example embodiments, a sanitary wrap 200 is to be provided and used with the dispensing cap 100a, 100b. According to example embodiments, the sanitary wrap 200 comprises a sanitary or anti-bacterial wipe 206 encased within a foil package or pouch 202. According to example embodiments, one or more sanitary wraps 200 are provided to a party of one or more people or guests (when seated) at a table in a restaurant. According to some example embodiments, branding or indicia can be provided on the sanitary wrap (or packaging thereof).

As depicted in FIGS. 7A-B, when it is desired to use either of the containers 10 (and dispensing caps 100a, 100b thereof), the user U tears open the foil pouch 202 and removes the wipe 206 therefrom. Without the user directly contacting the handle 140a, 140b, the user U cleans the handle 140a, 140b with the wipe 206 (see FIG. 7B). In some example embodiments, after the user U cleans one of the handles 140a, 140b, the user U then grasps the wipe 206 and begins cleaning the other handle 140a, 140b. As depicted in FIGS. 7C-D, the user U then takes the foil pouch 202 and inserts the desired handle 140a, 140b within an internal space or reservoir 204 of the foil pouch 202. Preferably, by covering the handle 140a, 140b with the foil pouch 202, a substantial barrier is provided between the user U (or fingers thereof) and the handle 140a, 140b, for example, so as to mitigate any risk of cross contamination or the spread of disease. And as depicted in FIG. 7D, the user U can freely grasp the handle 140b to manipulate the dispensing cap 100b (and container 10 thereof) so as to dispense a desired amount of the second granular material therefrom.

According to example embodiments, the present invention relates to method of preventing cross contamination in a restaurant when using condiments contained within containers. The method comprises providing one or more condiment containers, the one or more condiment containers each comprising a grasping handle extending therefrom; providing a sanitary wrap, the sanitary wrap comprising a sanitary wipe enclosed within a cover or foil pouch; opening the foil pouch; removing the sanitary wipe; wiping the grasping handle with the sanitary wipe; covering the grasping handle with the foil pouch; grasping the grasping handle while the foil pouch remains thereon; and manipulating the container so as to dispense the condiment. According to another example embodiment, the sanitary wrap and methods of use can be an effective way of preventing guests with food allergies from coming into contact with reactive allergens.

In other example methods of use, a guest or other user sitting at a dining table or other setting can merely open the foil pouch and remove the sanitary wipe 206 therefrom. The wipe 206 can be used to wipe or clean the grasping handle on one or more of the containers. Thereafter, the wipe 206 can be used to clean the table and other table items, for example, such as the menu or other condiment containers. When it is desired to use one or more of the containers, the foil pouch 202 is placed or slipped over the elongate body of the grasping handle such that an entirely sanitary barrier is provided between a guest's body and the grasping handle, thereby providing an entirely sanitary solution, eliminating the likelihood of any cross contamination. In example embodiments, the sanitary wrap is configured so as to benefit one or more guests with both a sanitized dining area as well as protection against the spread of germs and disease.

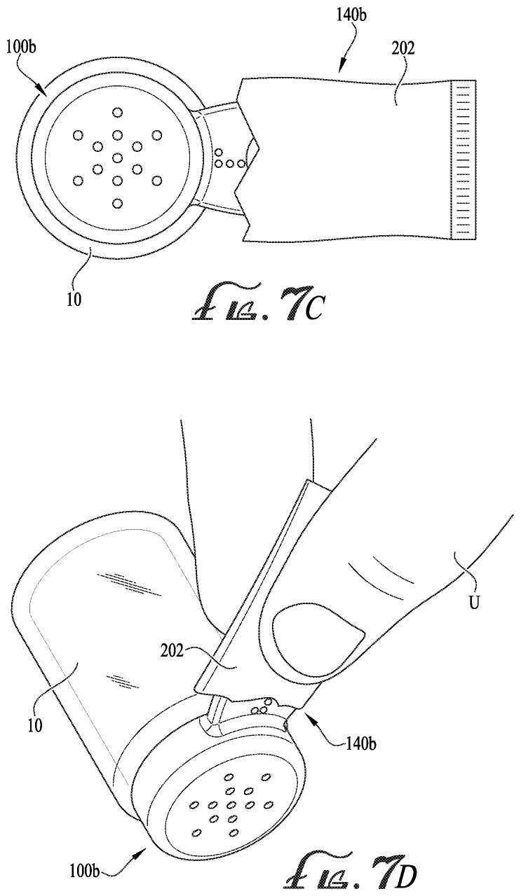

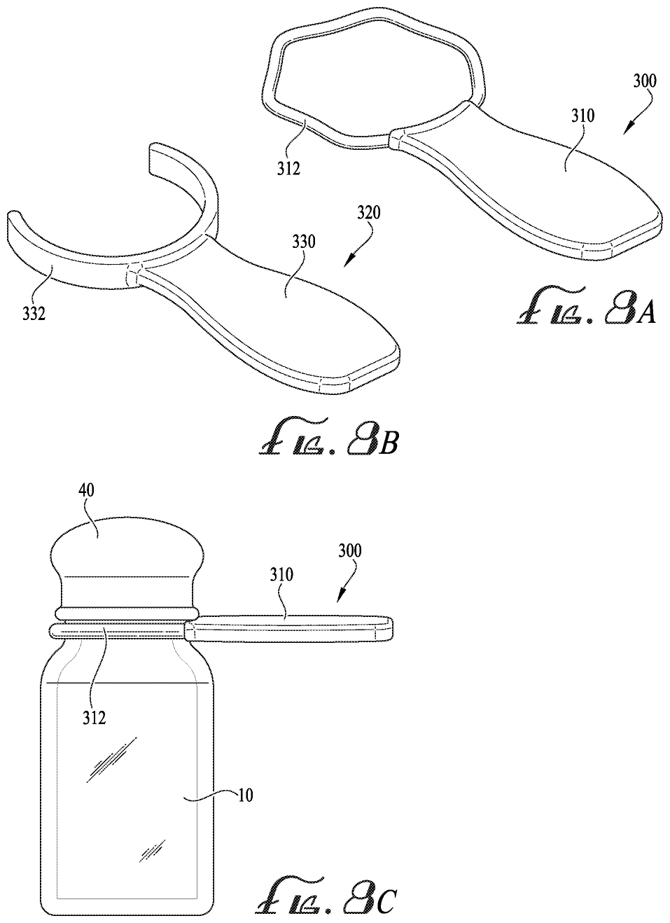

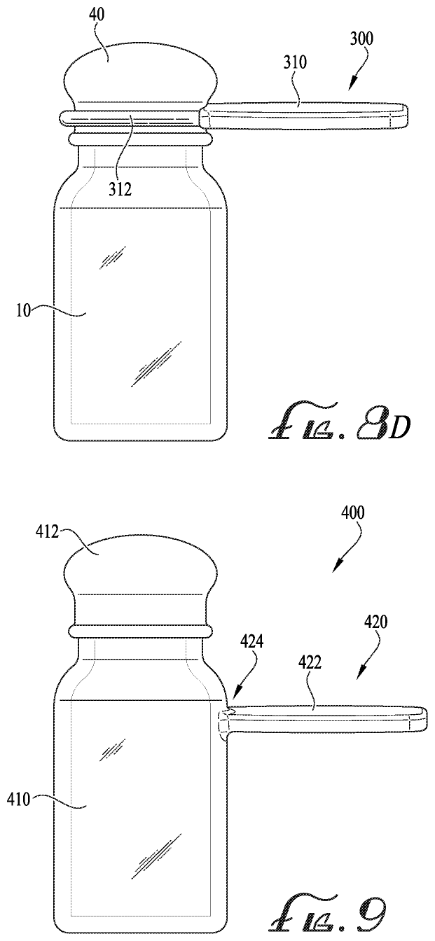

FIGS. 8A-9 show additional example embodiments of the present invention. For example, according to one example embodiment, separate grasping handles 300, 320 can be provided for attachment to a container 10 as desired. As depicted in FIG. 8A, the grasping handle 300 includes a generally elongate body 310 and an attachment portion 312. The attachment portion 312 is generally integrally formed with the body 310. According to example embodiments, the attachment portion 312 is at least partially elastic and resilient, for example, which is configured to securely and removably engage at least a portion of the container 10, and for example, permit a user U to grasp the body 310 so as to manipulate the container 10 to dispense the granular material from the contained volume of the body of the container 10

As depicted in FIG. 8C, the attachment portion 312 is preferably integrally formed with the elongate body 310, and the attachment portion 312 preferably provides for removable attachment to at least a portion of the container 10. In alternate example embodiments, the attachment portion 312 is a separate piece and connects with the elongate body 310. In some example embodiments, the attachment portion 312 is permanently mounted to the container 10. According to example embodiments, the cap 40 can preferably be removed from the threaded connector without removal of the grasping handle 300 from the container 10. According to some example embodiments, the attachment portion 312 is removably engaged with an upper neck portion of the container 10 (see FIG. 8C). According to another example embodiment, the attachment portion is removably engaged with a collar, channel or groove defined within a portion of the cap 40.

Optionally, as depicted in FIG. 8B, the grasping handle 320 can comprise an elongate body 330 and an attachment portion 332. According to one example embodiment, the attachment portion 332 comprises a clip or snap-like coupling, for example, a C-shaped connector that is configured to at least removably connect with at least a portion of the container 10 or cap 40 thereof. According to one example embodiment, the attachment portion 332 comprises a resilient clip that is configured to at least partially flex so as to permit secure and removable engagement with at least a portion of the container 10 or cap 40. For example, according to example embodiments, the attachment portion 332 can similarly connect with the container 10 or cap 40 as depicted in FIGS. 8C-D.

FIG. 9 shows a container assembly 400 according to another example embodiment of the present invention. As depicted, a grasping handle 420 is permanently mounted to the body of the container 410. In example embodiments, the assembly comprises the container 410, the cap 412 coupled with the container 410, and the grasping handle 420 mounted to at least a portion of the container 10. In example embodiments, a first end 424 of the body 422 of the grasping handle 420 is permanently mounted with an external surface of the container 410. In alternate example embodiments, the grasping handle can be removably mounted to the container. In another example embodiment, the grasping handle 420 is integrally formed with the body of the container 410. In yet another example embodiment, the body of the container and the grasping handle comprise one or more interengagement features for providing coupling engagement of the grasping handle 420 with the body of the container.

According to example embodiments, the grasping handles as described herein can preferably sized and shaped as desired, and can preferably be formed from any desired material including plastics, composites, metals, natural materials, synthetic materials, and/or combinations thereof as desirable. In a similar matter, the containers and caps as described herein can be formed from any desired material including plastics, metals, glass, composites, natural materials, wood, synthetic materials, polymers, and/or combinations thereof.

In example embodiments, the present invention including the container and grasping handle provides an important step forward in the cleanliness and sanitation of the most highly contaminated restaurant items, for example, salt and pepper shakers according to one example embodiment.

In example embodiments, a bacteria and biofilm wash and barrier protocol is used with the grasping handle, for example, which serves to virtually eliminate the possibility of cross contamination and the spread of disease in the restaurant setting.

In example embodiments, the grasping handle is designed to allow maximum comfort of use by incorporating several features into the user/product interface. According to one example embodiment, the grasping handle is provided with a 2.5-12 degree tilt from horizontal, which allows easy pick up and placement with no odd angulations of the wrist or digits. Proper control of the application process is facilitated by the subtle contours and concavities found in the unique custom handle design.

According to some example embodiments, one or more containers comprising a grasping handle extending therefrom can be used with standard condiment racks or trays (or caddies) that are typically present on restaurant tables.

According to example embodiments, the grasping handle is to be used with a sanitary wrap. According to example embodiments, the sanitary wrap comprises a sanitary or anti-bacterial wipe encased within a foil package or pouch. According to example embodiments, one or more sanitary wraps are provided to a party of one or more people or guests (when seated) at a table in a restaurant. According to some example embodiments, branding or indicia can be provided on the sanitary wrap (or packaging thereof).

According to an example embodiment, a replacement lid or cap can be provided, for example, which is compatible for coupling engagement with existing containers or shakers already present in a restaurant. In example embodiments and as described above, the can comprise the grasping handle integrally formed therewith. According to other example embodiments, the body of the shaker can comprise a grasping handle integrally formed therewith (or a separate piece that removably or permanently connects with the body).

According to one example embodiment, the present invention can be implemented in the hospitality industry, for example, at events, dinners, engagements or other places where one or more containers or objects that are prone to physical touch by many users. Accordingly, grasping handles and/or sanitary wraps can be provided so as to maintain an entirely sanitary environment without the risk of cross contamination.

While the invention has been described with reference to preferred and example embodiments, it will be understood by those skilled in the art that a variety of modifications, additions and deletions are within the scope of the invention, as defined by the following claims.

What is claimed is:

1. A dispensing cap for a container, the dispensing cap comprising:
a cylindrical body extending along a first axis and comprising a substantially closed end and an open end, the body comprising an outer peripheral surface defined between the substantially closed end and the open end; and
a grasping handle extending from the cylindrical body.

2. The dispensing cap of claim 1, wherein the grasping handle comprises an engaged end and a free end oppositely extending from the engaged end, the engaged end generally connected to at least a portion of the cylindrical body, and the free end comprising a grasping portion proximal thereto.

3. The dispensing cap of claim 2, wherein the grasping handle is integrally formed with the cylindrical body.

4. The dispensing cap of claim 2, wherein the grasping handle is removably connected with the cylindrical body.

5. The dispensing cap of claim 2, wherein the engaged end is engaged with at least a portion of the outer peripheral surface of the cylindrical body.

6. The dispensing cap of claim 1, further comprising at least one opening formed in the substantially closed end of the cylindrical body.

7. The dispensing cap of claim 1, further comprising threads formed on an interior portion of the outer peripheral surface of the cylindrical body for providing removable engagement with a threaded connector of a container.

8. The dispensing cap of claim 1, wherein the open end of the cylindrical body is configured for removable engagement with a connector of the container, and wherein the grasping handle thereof can be grasped so as to manipulate the container.

9. The dispensing cap of claim 1, wherein the container comprises a condiment container comprising a contained space for containing at least some quantity of a granular material.

10. The dispensing cap of claim 2, wherein a maximum dimension is defined between an outermost portion of the free end of the grasping handle and an opposite and outermost portion of the outer peripheral surface of the cylindrical body, wherein the maximum dimension is about 3.105 inches.

11. The dispensing cap of claim 2, wherein the grasping handle is oriented to be at least partially angled relative to a horizontal axis that is generally extending transverse relative to the first axis, the grasping handle defining an included angle of about 5 degrees relative to the horizontal axis.

12. The dispensing cap of claim 1, wherein the grasping handle comprises an upper surface and a lower surface, the upper surface comprising at least one Braille letter formed thereon.

13. A condiment assembly comprising:
a first container comprising a threaded connector and an internal volume for containing a first granular material;
a second container comprising a threaded connector and an internal volume for containing a second granular material;
a first dispensing cap configured for removable engagement with the threaded connector of the first container; and
a second dispensing cap configured for removable engagement with the threaded connector of the second container,
wherein the first and second dispensing caps each comprise a cylindrical body and a grasping handle, the cylindrical body comprising a substantially closed end and an open end, the cylindrical body comprising an outer peripheral surface defined between the substantially closed end and the open end, and the grasping handle comprising an engaged end and a free end oppositely extending therefrom, and wherein the grasping handles of the first and second dispensing caps overlap each other in a nested configuration and are misaligned in a non-nested configuration.

14. The condiment assembly of claim 13, wherein at least some spacing or clearance is provided between a lower surface of an upper grasping handle and an upper surface of a lower grasping handle.

15. The condiment assembly of claim 14, wherein the spacing between the dispensing caps is at least about 0.034 inches.

16. The condiment assembly of claim 13, wherein each of the first and second dispensing caps define a maximum dimension that is defined between an outermost portion of the free end of the grasping handle and an opposite and outermost portion of the outer peripheral surface of the cylindrical body, wherein the maximum dimension is about 3.105 inches.

17. The condiment assembly of claim 16, wherein in the nested configuration, a maximum dimension is defined between outermost and opposite sides of the outer peripheral surfaces of the cylindrical bodies and with the grasping handles overlapping each other, wherein the maximum dimension is about 4.619 inches.

18. The condiment assembly of claim 17, wherein the maximum dimension of the dispensing caps in the nested configuration is about 1.5 times greater than the maximum dimension of one of the dispensing caps, and wherein the maximum dimension of the dispensing caps in the nested configuration is about 26% less than twice the maximum dimension of one of the dispending caps.

19. A method of preventing cross contamination in a restaurant when using condiments contained within containers, the method comprising:
providing one or more condiment containers, the one or more condiment containers each comprising a grasping handle extending therefrom;
providing a sanitary wrap, the sanitary wrap comprising a sanitary wipe enclosed within a cover or foil pouch;
opening the foil pouch;
removing the sanitary wipe;
wiping the grasping handle with the sanitary wipe;
covering the grasping handle with the foil pouch;
grasping the grasping handle while the foil pouch remains thereon; and
manipulating the container so as to dispense the condiment.

20. The method of claim 18, further comprising using the sanitary wipe to clean a table, a menu or other potentially unsanitary objects present on a table at the restaurant.

21. A container comprising:
a body extending from a first end to a second end, the first end comprising a threaded coupling having an opening extending therethrough, and the second end comprising a base or resting surface, and wherein the threaded coupling comprises an opening for access within a contained volume of the body;
a cap comprising a collar having a substantially closed end and an open end, the substantially closed end comprising one or more passageways defined therethrough, and an inner surface of the collar comprising threads compatible for coupling engagement with the threaded coupling of the body; and
a grasping handle extending from at least a portion of the body and/or cap, wherein the grasping handle is configured so that a user can grasp it for manipulation of the container such that one or more materials contained within the contained volume can be dispensed from the passageways of the substantially closed end.

22. The container of claim 21, wherein the grasping handle is removably attached to the body or the cap.

23. The container of claim 21, wherein the grasping handle is integrally formed with the body or the cap.
